(19) United States
(12) Patent Application Publication
(10) Pub. No.: US 2026/0133587 A1
(43) Pub. Date: May 14, 2026

(54) METHOD FOR INDUSTRIAL SITE MONITORING BASED SKELETON, AND COMPUTER PROGRAM RECORDED ON RECORD-MEDIUM FOR EXECUTING METHOD THEREFOR

(71) Applicant: BRILS Co., Ltd., Incheon (KR)

(72) Inventor: Jin JEON, Incheon (KR)

(73) Assignee: BRILS Co., Ltd., Incheon (KR)

(21) Appl. No.: 19/219,417

(22) Filed: May 27, 2025

(30) Foreign Application Priority Data
Nov. 11, 2024 (KR) 10-2024-0159198

(51) Int. Cl. G05D 1/633; G05D 101/20; G05D 107/70; G06T 7/215; G06T 7/246; G06V 20/40; G06V 40/20

(52) U.S. Cl. CPC G05D 1/633; G06T 7/215; G06T 7/251; G06V 20/40; G06V 40/20; G05D 2101/20; G05D 2107/70; G06T 2207/10016; G06T 2207/20021; G06T 2207/30196; G06V 2201/06

(57) ABSTRACT

The present invention proposes a skeleton-based industrial site monitoring method that predicts a worker's movement path through skeleton analysis based on video footage captured by cameras installed throughout the industrial site, thereby preventing path overlap with a robot. The method includes the following steps: generating skeleton data by recognizing joint points of a worker based on a captured video of the industrial site where a robot is present, estimating an expected movement path of the worker based on the generated skeleton data, searching for an optimal path for the robot to avoid collision with the worker based on the estimated expected movement path of the worker, and controlling the robot according to the searched optimal path.

### CROSS-REFERENCE TO RELATED APPLICATIONS AND CLAIM OF PRIORITY

The present application claims priority to Korean Patent Application No. 10-2024-0159198, filed on Nov. 11, 2024, the entire contents of which are incorporated herein for all purposes by this reference.

### TECHNICAL FIELD

The present invention relates to an automation system, and more particularly, to a skeleton-based industrial site monitoring method for preventing path overlap between a worker and a robot by predicting the worker's movement path through skeleton analysis based on video footage captured by cameras installed throughout an industrial site, and to a computer program recorded on a recording medium for executing the same.

### BACKGROUND

A logistics automation system refers to a system that automates tasks such as packaging, loading and unloading, and transportation—which are labor-intensive processes within logistics activities involving the movement of a product from a producer to a consumer—based on Internet of Things (IoT), robot, and Artificial Intelligence (AI) technologies.

Meanwhile, a collaborative robot refers to a partner-type robot that collaborates with humans in a space not separated from them. Due to its relatively low cost and adaptability across various industrial fields, it has recently gained significant attention. In addition, collaborative robots offer advantages such as ease of operation and flexibility in reconfiguring processes compared to conventional industrial robots, making them suitable for a wide range of tasks and processes. Unlike conventional industrial robots that primarily perform repetitive tasks, recent collaborative robots are evolving into fusion systems integrated with IT (Information & Communication Technology) such as artificial intelligence, human interfaces, and ubiquitous networks.

To implement collaborative work between humans and collaborative robots, it is essential to satisfy three key characteristics: safety, coexistence, and collaboration. In particular, safety refers to the capability of avoiding collisions with workers or, when unavoidable, the ability of the robot to detect the collision and respond to minimize the associated risk.

Recently, in order to ensure safety in human-robot collaborative operations, regulations have required the installation of fences or responsive protective devices in the work area. However, such measures alone have proven insufficient to guarantee the safety of workers.

### SUMMARY

One object of the present invention is to provide a skeleton-based industrial site monitoring method that can prevent path overlap between a worker and a robot by predicting the worker's movement path through skeleton analysis based on video footage captured by cameras installed throughout an industrial site.

Another object of the present invention is to provide a computer program recorded on a recording medium for executing the skeleton-based industrial site monitoring method, which prevents path overlap between a worker and a robot by predicting the worker's movement path through skeleton analysis based on video footage captured by cameras installed throughout an industrial site.

The technical problems to be solved by the present invention are not limited to those mentioned above, and other technical problems not explicitly mentioned will be clearly understood by those skilled in the art from the following description.

To achieve the above-described technical problems, the present invention proposes a skeleton-based industrial site monitoring method that can prevent path overlap between a worker and a robot by predicting the worker's movement path through skeleton analysis based on video footage captured by cameras installed throughout an industrial site. The method may include a control server recognizing joint points of a worker from video footage of an industrial site where a robot is present and generating skeleton data, the control server estimating the expected movement path of the worker based on the generated skeleton data, the control server searching for an optimal path for the robot to avoid collision with the worker based on the estimated movement path of the worker, and the control server controlling the robot according to the searched optimal path.

The estimating step is characterized in that it estimates the movement direction and speed of the worker based on changes in the positions of body key points of the worker using the generated skeleton data, and estimates the expected movement path based on the estimated movement direction and speed of the worker.

The estimating step is also characterized in that it estimates a type of task based on the estimated expected movement path, and corrects the estimated expected movement path based on the estimated type of task.

The controlling step is characterized in that it tracks the movement of the worker, matches the tracked movement of the worker with the estimated expected movement path in real time, and recognizes the movement as an abnormal when the distance between the movement of the worker and the expected movement path exceeds a preset value.

The controlling step is also characterized in that it divides the video into a dynamic region set based on the expected movement path and a static region corresponding to the remaining area of the video excluding the dynamic region, and tracks the movement of the worker by analyzing the dynamic region.

The controlling step is characterized in that it generates a virtual worker of a preset size based on the skeleton data, and sets the dynamic region based on the movement of the generated virtual worker along the expected movement path.

The controlling step is characterized in that it performs masking on the separated static region.

The controlling step is also characterized in that it tracks the movement of the worker based on the skeleton data, estimates a risk level based on the difference between the expected movement path and the worker's actual movement, and resets the expected movement path when the estimated risk level exceeds a preset value.

The controlling step is further characterized in that it estimates a risk level based on the difference between the reset expected movement path and the worker's movement, compares the risk level according to the reset expected movement path with the risk level according to the previous expected movement path, and outputs a warning signal when the difference between the risk levels is less than a preset value.

The computer program may be combined with a computing device that includes a transceiver, a memory, and a processor that processes instructions stored in the memory. The computer program may be a program recorded on a recording medium to execute steps in which the processor recognizes joint points of a worker from video footage of an industrial site where a robot is present to generate skeleton data, estimates the expected movement path of the worker based on the generated skeleton data, searches for an optimal path for the robot to avoid collision with the worker based on the estimated movement path of the worker, and controls the robot according to the searched optimal path.

Specific details of other embodiments are included in the following detailed description and the drawings.

### BRIEF DESCRIPTION OF THE DRAWINGS

FIG. 1 is a block diagram showing the configuration of a logistics automation system according to an embodiment of the disclosure.

FIG. 2 is an illustrative diagram for explaining an industrial site in which the logistics automation system according to an embodiment of the disclosure is implemented.

FIG. 3 is a logical block diagram of a control server according to an embodiment of the disclosure.

FIGS. 4 and 5 are illustrative diagrams for explaining a process for estimating an expected movement path of a worker according to an embodiment of the disclosure.

FIG. 6 is an illustrative diagram for explaining a path searching process according to an embodiment of the disclosure.

FIG. 7 is an illustrative diagram for explaining a robot control process according to an embodiment of the disclosure.

FIG. 8 is an illustrative diagram for explaining a de-identification function according to an embodiment of the disclosure.

FIG. 9 is a hardware block diagram of a control server according to an embodiment of the disclosure.

FIG. 10 is a flowchart for explaining a path setting method for a robot based on the shape of an object according to an embodiment of the disclosure.

FIG. 11 is a flowchart for explaining a skeleton-based industrial site monitoring method according to an embodiment of the disclosure.

### DETAILED DESCRIPTION

It should be noted that the technical terms used in this specification are intended merely to describe specific embodiments and are not intended to limit the scope of the disclosure. Unless otherwise defined herein, the technical terms used in this specification should be interpreted as having meanings generally understood by those skilled in the art to which the disclosure pertains, and should not be interpreted in an unduly broad or unduly narrow sense.

If any technical term used herein fails to accurately reflect the idea of the disclosure, it should be understood as being replaced with a term that can be correctly understood by those skilled in the art. In addition, general terms used in the disclosure should be interpreted in accordance with their definitions or the context in which they are used, and should not be interpreted in an unduly restricted manner.

In addition, the singular expressions used in this specification are intended to include the plural forms unless the context clearly indicates otherwise. In the present application, terms such as “comprise” or “have” should not be interpreted as necessarily including all elements or steps recited in the specification. Rather, some of the elements or steps may be omitted, or additional elements or steps may be included.

Furthermore, ordinal terms such as “first,” “second,” and the like used in this specification may be employed to describe various elements, but the elements should not be limited by such terms. These terms are only used to distinguish one element from another. For example, without departing from the scope of the disclosure, a “first” element may be referred to as a “second” element, and similarly, a “second” element may be referred to as a “first” element.

When an element is referred to as being “connected to” or “coupled to” another element, it may be directly connected or coupled to the other element, or one or more intervening elements may be present. In contrast, when an element is referred to as being “directly connected to” or “directly coupled to” another element, it should be understood that there are no intervening elements present.

Hereinafter, preferred embodiments of the disclosure will be described in detail with reference to the accompanying drawings. In the drawings, the same reference numerals are assigned to the same or similar components regardless of whether the drawings differ, and repeated descriptions thereof will be omitted. In addition, in describing the disclosure, detailed descriptions of related known technologies will be omitted when they may obscure the gist of the disclosure.

It should also be noted that the accompanying drawings are provided for the purpose of facilitating understanding of the spirit of the disclosure, and the spirit of the disclosure should not be construed as being limited by the drawings. The spirit of the disclosure should be construed to extend to all modifications, equivalents, and substitutions beyond the drawings.

Meanwhile, as described above, in order to implement collaborative work between humans and collaborative robots, three key characteristics must be satisfied: safety, coexistence, and collaboration.

In particular, safety refers to the ability to avoid collisions with workers, or the ability of the robot to detect an unavoidable collision and respond to mitigate the associated risk.

Recently, in order to ensure safety in the implementation of collaborative work between collaborative robots and humans, regulations have required the installation of fences or responsive protective devices in the work area. However, such measures alone have proven insufficient to ensure the safety of workers.

To overcome these limitations, the present disclosure proposes various means for setting a robot's path that can avoid collisions with workers.

According to an embodiment of the disclosure, by monitoring the movement of a worker and the expected movement path in real time through skeleton analysis, it is possible to synchronize the path of the worker with that of the robot to preemptively prevent collision risks. Furthermore, by designing a safe working area where the worker and the robot can operate simultaneously, efficient spatial arrangement and utilization of the worksite can be achieved.

The effects of the present disclosure are not limited to those mentioned above, and other effects not explicitly stated will be clearly understood by those skilled in the art from the descriptions of the claims.

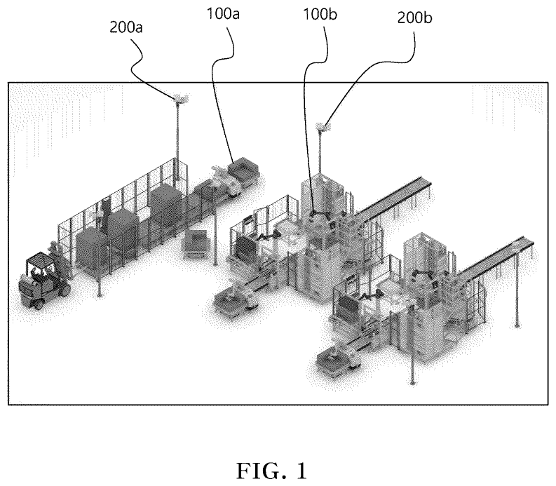

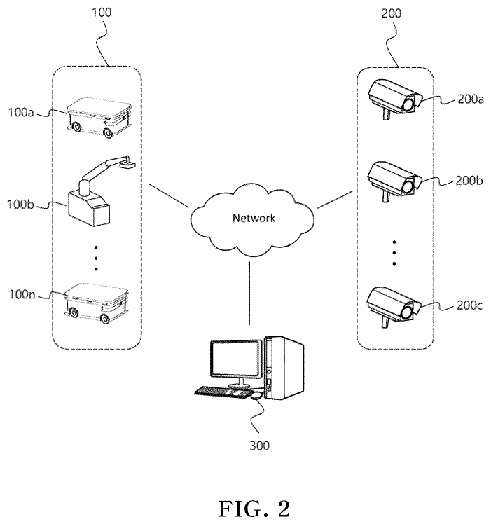

FIG. 1 is a block diagram showing the configuration of a logistics automation system according to an embodiment of the disclosure, and FIG. 2 is an illustrative diagram for explaining an industrial site in which the logistics automation system according to an embodiment of the disclosure is implemented.

Referring to FIGS. 1 and 2, a logistics automation system according to an embodiment of the disclosure may include at least one robot (100a, 100b, . . . , 100n; 100), at least one camera (200a, 200b, . . . , 200n; 200), and a control server (300).

The components of the logistics automation system according to an embodiment of the disclosure, as described above, merely represent functionally distinct elements. In an actual physical environment, two or more of these components may be implemented in an integrated manner, or a single component may be implemented as separate physical elements.

Describing each component in more detail, the robot (100) may be a device capable of performing tasks such as transporting, loading, and sorting goods within an industrial site.

In one embodiment, the robot (100a) may be a device for transporting goods based on autonomous driving. Here, the robot (100a) may be one of an Automated Guided Vehicle (AGV) or an Autonomous Mobile Robot (AMR).

In another embodiment, the robot (100b) may be a device for gripping and relocating goods. Here, the robot (100b) may be a palletizing robot, a picking robot, or the like.

In a subsequent configuration, the camera (200) may be installed throughout the industrial site to capture video of the robot (100) or a worker performing tasks in collaboration with the robot (100). The camera (200) may also capture video footage of the industrial site and transmit it to the control server (300) in real time. Here, the camera (200) may be a Closed-Circuit Television (CCTV) used for purposes such as security and surveillance within the industrial site.

The video acquired from the camera (200) may be used to analyze the shape of the object to be handled by the robot (100), the movement of the robot (100), and the movement of the worker, and may be utilized to search for an optimal path for the robot (100) to avoid collisions with the worker. In addition, the video acquired from the camera (200) may be used to analyze the shape of the worker and to monitor the worker's condition, including whether personal protective equipment is being worn.

In a subsequent configuration, the control server (300) may integrally control the movements of a plurality of robots (100) used within the industrial site. The control server (300) may also monitor the conditions of workers who collaborate with the robots (100) in performing tasks at the industrial site. Such a control server (300) may also be referred to as a Remote Control System (RCS).

The control server (300) is not limited to the term “server,” and may be any device capable of transmitting and receiving data with at least one robot (100) and at least one camera (200), and performing computations based on the transmitted and received data. For example, the control server (300) may be one of various fixed computing devices, such as a desktop or a workstation, but is not limited thereto.

In one embodiment, the control server (300) may identify the shape of an object to be transported by the robot (100) based on video footage of the industrial site where the robot (100) is operating. Subsequently, the control server (300) may simulate a work path related to the movement of the robot (100) based on the identified shape of the object, and may search for an optimal path to avoid collisions with a worker. The control server (300) may then control the robot (100) according to the searched optimal path.

In another embodiment, the control server (300) may recognize joint points of a worker based on video footage of an industrial site where the robot (100) is operating, and may generate skeleton data. Subsequently, the control server (300) may estimate the expected movement path of the worker based on the generated skeleton data. The control server (300) may search for an optimal path for the robot to avoid collisions with the worker based on the estimated expected movement path of the worker, and may control the robot (100) according to the searched optimal path.

For example, the optimal path of the robot (200) may correspond to a driving path when applied to an automated guided vehicle or an autonomous mobile robot, and may correspond to a movement path of a gripper for gripping an object when applied to a palletizing robot or a picking robot.

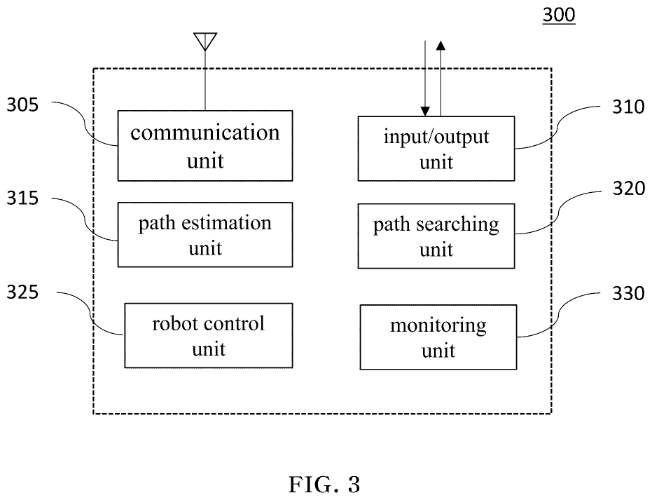

The detailed configuration and operation of the control server (300) will be described later with reference to FIGS. 3 through 8.

As described above, the robot (100), the camera (200), and the control server (300) may transmit and receive data using a network that includes one or more combinations of a secure dedicated line, a public wired communication network, and a mobile communication network.

For example, the public wired communication network may include, but is not limited to, Ethernet, x Digital Subscriber Line (xDSL), Hybrid Fiber Coax (HFC), and Fiber To The Home (FTTH). In addition, the mobile communication network may include, but is not limited to, Code Division Multiple Access (CDMA), Wideband CDMA (WCDMA), High Speed Packet Access (HSPA), Long Term Evolution (LTE), and 5th/6th generation mobile telecommunication.

Hereinafter, the configuration of the control server (300) according to an embodiment of the disclosure will be described in greater detail.

FIG. 3 is a logical block diagram of a control server according to an embodiment of the disclosure.

As shown in FIG. 3, the control server (300) according to an embodiment of the disclosure may include a communication unit (305), an input/output unit (310), a path estimation unit (315), a path searching unit (320), a robot control unit (325), and a monitoring unit (330).

The components of the control server (300) according to an embodiment of the disclosure merely represent functionally distinct elements. In an actual physical environment, two or more of these components may be implemented in an integrated manner, or a single component may be implemented as separate physical elements.

Specifically, the communication unit (305) may receive status information from the robot (100). The communication unit (305) may also transmit control commands to the robot (100). In addition, the communication unit (305) may receive video captured by the camera (200).

The communication unit (305) may also transmit and receive data through an Equipment InterFace (EIF) with systems such as a Manufacturing Execution System (MES), a Material Control System (MCS), and a Warehouse Management System (WMS).

In a subsequent configuration, the input/output unit (310) may receive information or commands from a user through a user interface (UI), and may output computation results externally. Specifically, the input/output unit (310) may receive commands related to the control of the robot (100), and may output status information of the robot (100).

In a subsequent configuration, the path estimation unit (315) may estimate an expected movement path of a worker who performs tasks in collaboration with the robot (100).

In one embodiment, the path estimation unit (315) may recognize the face of a worker in video captured by the camera (200), and may estimate the expected movement path of the worker based on the recognized face.

Specifically, the path estimation unit (315) may recognize the face of a worker using a pre-trained Artificial Intelligence (AI) model, and may extract at least one of a position, direction, and gaze of the face based on characteristic data of the recognized face. Here, the position of the face may correspond to information about the location of the worker, and the direction and gaze may correspond to information indicating the direction in which the worker is facing.

Subsequently, the path estimation unit (315) may analyze the direction and gaze of the recognized face to determine the object that the worker is paying attention to or the direction in which the worker is likely to move. Here, the direction of the face may include a horizontal rotation angle and a vertical angle. The extraction of the face direction may be performed through analysis of facial feature points. That is, the path estimation unit (315) may extract facial points such as the eyes, nose, mouth, and ears of the worker and may calculate the angle of the face. In addition, gaze information may be estimated based on the position and direction of the eyes and may be used to predict the direction in which the worker is looking. For example, if the face of the worker rotates in a certain direction and then the worker begins to move, the path estimation unit (315) may predict a high likelihood of movement in that direction. Through this process, the path estimation unit (315) may record how the worker's movement path changes and may reflect it in the expected movement path.

In another embodiment, the path estimation unit (315) may recognize joint points of a worker based on video captured by the camera (200) to generate skeleton data, and may estimate the expected movement path of the worker based on the generated skeleton data.

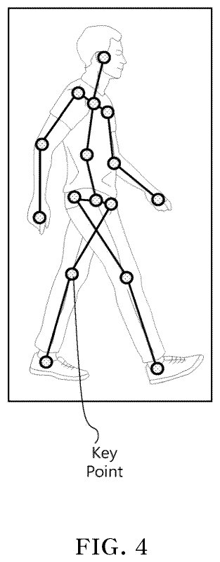

Referring to FIG. 4, an example of estimating the expected movement path of a worker by the path estimation unit (315) according to an embodiment of the disclosure will be described.

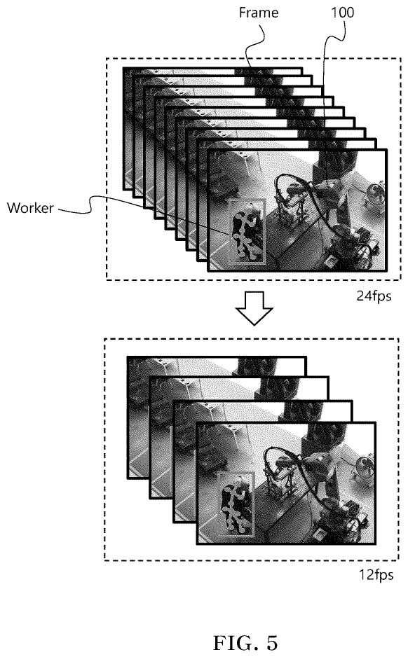

FIGS. 4 and 5 are illustrative diagrams for explaining a process of estimating an expected movement path of a worker according to an embodiment of the disclosure.

As shown in FIG. 4, skeleton data refers to data related to the three-dimensional skeleton of an object in an image, which is used to identify the body shape, pose, or direction of the object.

Such skeleton data may include one or more key points corresponding to positions that serve as reference points for changes in the body shape, pose, or direction of the object (e.g., joints). The one or more key points included in the skeleton data represent the positions that serve as references for changes in the body shape, pose, or direction of the object. In addition, the number, connection relationships, and required positions of the one or more key points that constitute the skeleton data may be predefined according to the attributes of the object.

For example, in the case of skeleton data based on a 3D human pose model, the data may be composed of 16 key points connected according to the major skeletal structure of the human body. Among the 16 key points, key point 1 corresponds to the left hip, key point 2 to the left knee, key point 3 to the left foot, key point 4 to the right hip, key point 5 to the right knee, key point 6 to the right foot, key point 7 to the center of the torso, key point 8 to the upper torso, key point 9 to the neck, key point 10 to the center of the head, key point 11 to the right shoulder, key point 12 to the right elbow, key point 13 to the right hand, key point 14 to the left shoulder, key point 15 to the left elbow, and key point 16 to the left hand, with each position being predefined.

The path estimation unit (315) may extract skeleton data including body joint coordinates from video captured by the camera (200) based on a pre-trained pose estimation algorithm. Then, the path estimation unit (315) may analyze the current position and posture of the worker based on the extracted skeleton data. That is, the path estimation unit (315) may determine not only the overall position of the worker but also the directions of the head, arms, and legs through the coordinates of each joint. Here, the analyzed posture may serve as seed information for predicting the worker's future actions.

The path estimation unit (315) may also track the movement path of the worker in real time using the skeleton data of the worker. Here, the movement path may be generated by connecting the position coordinates extracted from each frame in the video, and may be used to identify patterns such as how the worker moves within a specific area where collaboration with the robot (100) takes place and in which area the worker stays.

The path estimation unit (315) may estimate the movement direction and speed of the worker based on changes in the positions of body feature points, using the skeleton data generated by a pre-trained artificial intelligence model, and may estimate an expected movement path based on the estimated movement direction and speed of the worker.

At this time, the path estimation unit (315) may estimate a type of task based on the estimated expected movement path and may correct the estimated expected movement path based on the estimated task type. That is, the path estimation unit (315) may analyze the behavior of the worker to predict the type of task currently being performed. In addition, the path estimation unit (315) may analyze the correlation between the estimated expected movement path and the task type and may correct the expected movement path accordingly. For example, a worker engaged in transporting objects is more likely to exhibit a fast and linear movement pattern, whereas a worker performing organizing tasks is more likely to remain within a specific area.

Meanwhile, the method of estimating the expected movement path of a worker according to the various embodiments described above is performed by analyzing video acquired from the camera (200). In this case, the path estimation unit (315) may reduce the computational load by adjusting the frame rate of the video according to specific situations during the video analysis.

In one embodiment, the path estimation unit (315) may track the movement of a worker by analyzing multiple frames included in the video, and may dynamically control the frame rate of the video in real time according to the number of workers recognized in the video. For example, when the number of workers is large, the path estimation unit (315) may increase the frame rate to track detailed movements using more frames, whereas when there are few or no workers, the frame rate may be reduced to minimize computational load.

In another embodiment, the path estimation unit (315) may track the movement of a worker by analyzing multiple frames included in the video, estimate a workload based on the movement of the worker, and dynamically control the frame rate of the video in real time according to the estimated workload. For example, when the workload is high, the path estimation unit (315) may increase the frame rate to track detailed movements using more frames, whereas when the workload is low or absent, the frame rate may be reduced to minimize computational load.

That is, when multiple workers are present in the video or the workload is high, the path estimation unit (315) may increase the frame rate to collect more data, as it is necessary to observe and track each worker's movement in greater detail. Conversely, when there are fewer workers or little to no activity, the path estimation unit (315) may reduce the frame rate to conserve system resources and power consumption, and optimize the process to prevent unnecessary data generation. For example, as shown in FIG. 5, when the number of workers included in the video decreases from two to one during the process of tracking the worker's position using skeleton data, the path estimation unit (315) may reduce the frame rate to a preset value.

As such, since the path estimation unit (315) adjusts the frame rate in real time whenever the number of workers changes, it can promptly reflect changes in the situation at the worksite and significantly enhance the flexibility and resource efficiency of the system.

In a subsequent configuration, the path searching unit (320) may search for an optimal path for the robot (100) to avoid collisions with the worker.

In one embodiment, the path searching unit (320) may identify the shape of an object to be transported by the robot (100) based on video collected from the camera (200). Specifically, the path searching unit (320) may utilize an object detection model capable of recognizing objects in the video to extract data such as the shape, size, color, and position of the object to be transported.

Subsequently, the path searching unit (320) may test various paths for moving the object to a designated location while it is being held, through simulation, and may predict potential collision risks with the worker. For example, the path searching unit (320) may implement a virtual environment similar to the real world by reflecting physical characteristics of the actual object, such as its shape, size, and weight, and may test various paths within the implemented environment.

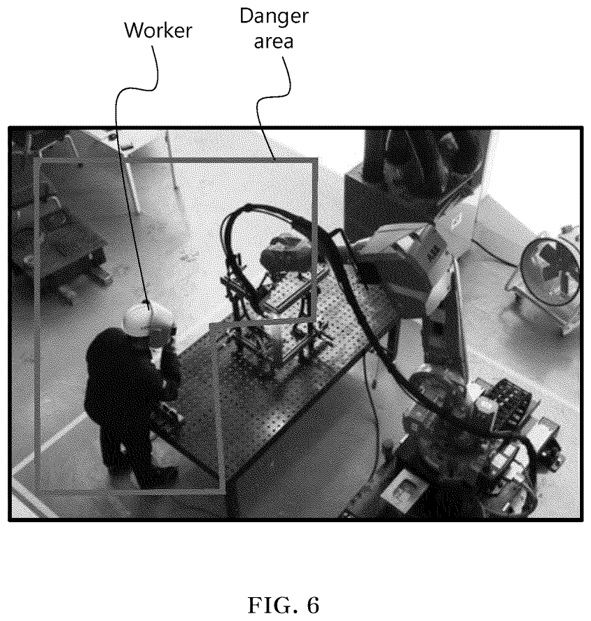

Referring to FIG. 6, an example of a path searching process performed by the path searching unit (320) according to an embodiment of the disclosure will be described.

FIG. 6 is an illustrative diagram for explaining a path searching process according to an embodiment of the disclosure.

As shown in FIG. 6, the path searching unit (320) may define a danger area corresponding to the worker's range of motion and may search for an optimal path for transporting the object within a safe area excluding the danger area, based on the shape of the object. Here, the danger area may be set according to the expected movement path of the worker estimated by the path estimation unit (315). However, the danger area is not limited thereto and may alternatively be designated arbitrarily by an administrator.

In another embodiment, the path searching unit (320) may search for an optimal path for the robot to avoid collisions with the worker based on the expected movement path of the worker estimated by the path estimation unit (315). That is, the path searching unit (320) may set an optimal path for the robot (100) that avoids the worker's movement path. For example, the path searching unit (320) may search for the fastest possible optimal path that avoids the expected movement path of the worker. Here, the path searching unit (320) may set the path to maintain a safe distance from the worker by taking into account the position of the worker and the expected movement path.

In a subsequent configuration, the robot control unit (325) may control the robot (100) according to the searched optimal path.

Here, the robot control unit (325) may track the movement of the worker, match the tracked movement of the worker with the estimated expected movement path in real time, and recognize the movement as abnormal when the distance between the worker's movement and the expected movement path exceeds a preset value. That is, the robot control unit (325) may compare the current position of the tracked worker with the expected movement path in real time in terms of distance and direction. For example, the robot control unit (325) may calculate the Euclidean distance between the worker's current position and the expected movement path to evaluate the difference. Subsequently, the robot control unit (325) may continuously calculate how far the worker's position deviates from the expected movement path and determine whether the worker's movement is within a normal range based on whether the distance exceeds a certain threshold.

For example, when an abnormal movement is recognized, the robot control unit (325) may output a warning signal that can be perceived by the worker at the site, or may output a warning signal that can be recognized by an administrator to trigger safety measures such as temporarily pausing the movement of the robot (100).

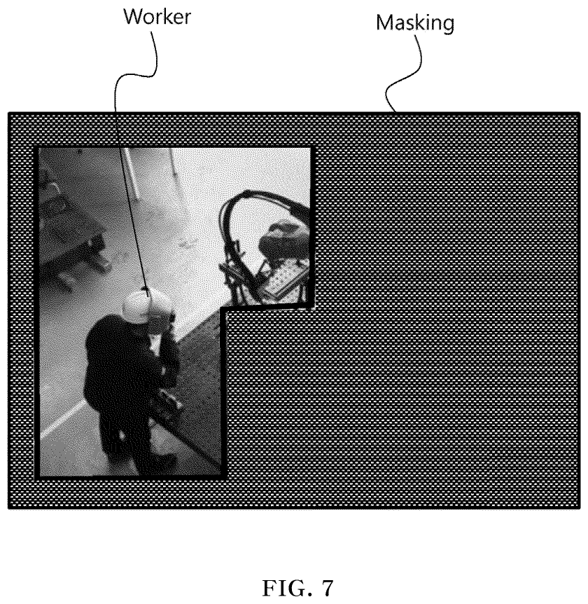

Referring to FIG. 7, an example of a robot control process performed by the robot control unit (325) according to an embodiment of the disclosure will be described.

FIG. 7 is an illustrative diagram for explaining a robot control process according to an embodiment of the disclosure.

As shown in FIG. 7, the robot control unit (325) may divide the image into a dynamic region, which is set based on the expected movement path of the worker, and a static region, which corresponds to the remaining area excluding the dynamic region, and may track the movement of the worker by analyzing the dynamic region. Here, the robot control unit (325) may generate a virtual worker of a preset size based on the skeleton data and may set the dynamic region based on the movement of the generated worker along the expected movement path. In this case, the robot control unit (325) may perform masking on the separated static region.

That is, analyzing the entire video to track the worker may lead to computational overload. Accordingly, the robot control unit (325) may perform masking on the static region that is not necessary for analysis and may analyze only the dynamic region, thereby reducing the computational load and enabling faster processing. In addition, by analyzing only the dynamic region corresponding to the region of interest in the video analysis, the robot control unit (325) may reduce errors in tracking the worker and improve the accuracy of the analysis.

The robot control unit (325) may also track the movement of the worker based on the skeleton data, estimate a risk level based on the difference between the expected movement path and the worker's actual movement, and reset the expected movement path when the estimated risk level exceeds a preset value. Here, the risk level may be calculated based on the difference between the expected movement path and the actual movement of the worker. In addition, the risk level may be calculated by considering at least one of the distance deviated from the expected movement path, the speed of deviation, and the risk level of the relevant area. For example, if the worker rapidly deviates from the expected movement path, a higher risk level may be calculated.

The robot control unit (325) may also estimate a risk level based on the difference between the worker's movement and the reset expected movement path, and may compare the risk level corresponding to the reset expected movement path with that of the previous expected movement path. If the difference in risk levels is less than a preset value, a warning signal may be output.

In a subsequent configuration, the monitoring unit (330) may output video captured by the camera (200) in real time to allow an administrator to monitor the situation at the industrial site. In this case, the monitoring unit (330) may output the video in real time while performing de-identification processing on the recognized face of the worker.

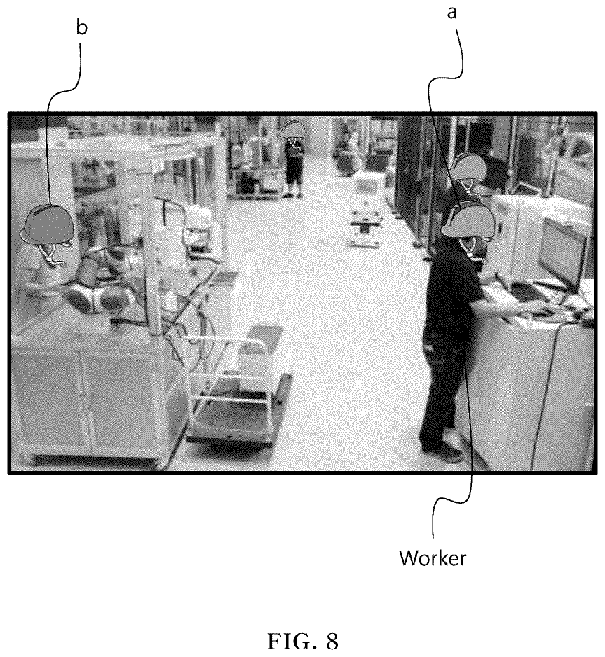

Referring to FIG. 8, an example of a de-identification function of the monitoring unit (330) according to an embodiment of the disclosure will be described.

FIG. 8 is an illustrative diagram for explaining the de-identification function according to an embodiment of the disclosure.

As shown in FIG. 8, the monitoring unit (330) may estimate whether the identified worker is wearing personal protective equipment based on the shape of the worker's recognized face, and may replace the recognized face in the video with a preset image according to the estimated result. For example, the monitoring unit (330) may replace and output the worker's face with an image of a safety helmet. That is, the monitoring unit (330) may output a blue safety helmet image (a) for a worker wearing a helmet, and a red safety helmet image (b) for a worker not wearing a helmet.

The monitoring unit (330) may also estimate the fatigue level of the identified worker based on at least one variation among the movement pattern, frequency, and speed of the identified worker, and may output the transformed image with a different color based on the estimated fatigue level.

Specifically, the monitoring unit (330) may estimate the fatigue level of the worker by analyzing the form and repetitive patterns of specific work actions through the skeleton data of the worker. For example, the monitoring unit (330) may estimate the fatigue level of the worker based on the number of occurrences of unnatural movements or inefficient movement patterns. In addition, the monitoring unit (330) may estimate the fatigue level based on changes in the speed of the worker's movements.

The monitoring unit (330) may also identify the torso of the recognized worker based on the worker's face, extract the edge of the identified torso, and modify the shape of the extracted edge based on a stored reference body shape. Specifically, the monitoring unit (330) may identify the torso region by applying the assumption that the body part located below the face position corresponds to the torso. However, the present disclosure is not limited thereto, and the monitoring unit (330) may also identify the position of the torso based on the skeleton data. Subsequently, the monitoring unit (330) may apply an edge detection algorithm to extract the edge of the identified torso region, and may apply shape modification to the differing portions by comparing the extracted torso edge with the edge shape corresponding to a reference body shape stored in a database.

As such, the monitoring unit (330) may protect the privacy of the worker through de-identification in the video, while also identifying factors such as whether the worker is wearing personal protective equipment and the worker's fatigue level, thereby enabling the administrator to intuitively understand the worker's condition.

Hereinafter, the hardware for implementing the logical components of the control server (300) as described above will be described in greater detail.

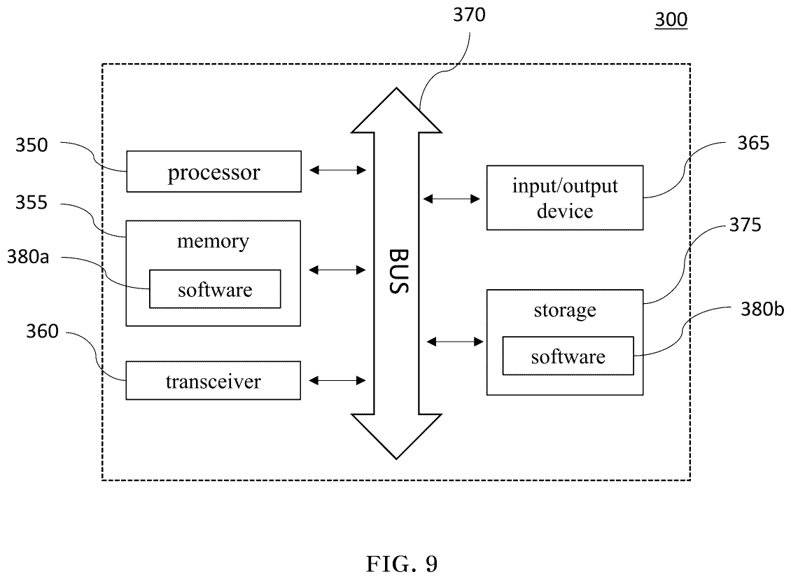

FIG. 9 is a hardware block diagram of a control server according to an embodiment of the disclosure.

As shown in FIG. 9, the control server (300) may include a processor (350), a memory (355), a transceiver (360), an input/output device (365), a data bus (370), and a storage (375).

Specifically, the processor (350) may implement the operations and functions of the control server (300) based on instructions according to software (380a), which implements the object-shape-based robot path setting method and the skeleton-based industrial site monitoring method, the software being stored in the memory (355).

The memory (355) may load software (380b), which implements the object-shape-based robot path setting method and the skeleton-based industrial site monitoring method, from the storage (375).

The input/output device (365) may receive signals required for the operation of the control server (300) or output computation results externally in response to commands from the processor (350).

The data bus (370) may be connected to the processor (350), the memory (355), the transceiver (360), the input/output device (365), and the storage (375), and may serve as a communication pathway for transmitting signals between the respective components.

The storage (375) may store application programming interfaces (APIs), library files, resource files, and the like, which are necessary for executing the software (380a) that implements the object-shape-based robot path setting method and the skeleton-based industrial site monitoring method according to embodiments of the present disclosure. The storage (375) may also store the software (380b) that implements the object-shape-based robot path setting method and the skeleton-based industrial site monitoring method according to embodiments of the present disclosure.

According to an embodiment of the present disclosure, the software (380a, 380b) for implementing the object-shape-based robot path setting method, which is loaded in the memory (355) or stored in the storage (375), may be a computer program recorded on a recording medium to execute the following steps: a step in which the processor (350) identifies the shape of an object to be transported by the robot based on video footage of an industrial site where the robot is present; a step in which the processor (350) simulates a work path of the robot based on the identified shape of the object and searches for an optimal path to avoid collisions with a worker; and a step in which the processor (350) controls the robot according to the searched optimal path.

According to another embodiment of the present disclosure, the software (380a, 380b) for implementing the skeleton-based industrial site monitoring method, which is loaded in the memory (355) or stored in the storage (375), may be a computer program recorded on a recording medium to execute the following steps: a step in which the processor (350) recognizes joint points of a worker based on video footage of an industrial site where the robot is present to generate skeleton data; a step in which the processor (350) estimates an expected movement path of the worker based on the generated skeleton data; a step in which the processor (350) searches for an optimal path for the robot to avoid collisions with the worker based on the estimated expected movement path of the worker; and a step in which the processor (350) controls the robot according to the searched optimal path.

More specifically, the processor (350) may include, but is not limited to, one or more of a Central Processing Unit (CPU), an Application-Specific Integrated Circuit (ASIC), a chipset, or a logic circuit.

The memory (355) may include, but is not limited to, one or more of a Read-Only Memory (ROM), a Random Access Memory (RAM), a flash memory, or a memory card.

The input/output device (365) may include, but is not limited to, one or more input devices such as buttons, switches, a keyboard, a mouse, and a joystick, and one or more output devices such as a Liquid Crystal Display (LCD), a Light Emitting Diode (LED), an Organic Light Emitting Diode (OLED), an Active Matrix OLED (AMOLED), a printer, and a plotter.

When the embodiments described in this specification are implemented in software, the above-described methods may be implemented as modules (procedures, functions, etc.) that respectively perform the above-described functions. Each module may reside in the memory (355) and may be executed by the processor (350). The memory (355) may be located either inside or outside the processor (350), and may be connected to the processor (350) by various known means.

Each component illustrated in FIG. 9 may be implemented by various means, such as hardware, firmware, software, or a combination thereof. When implemented in hardware, an embodiment of the present disclosure may be implemented using one or more of an Application-Specific Integrated Circuit (ASIC), a Digital Signal Processor (DSP), a Digital Signal Processing Device (DSPD), a Programmable Logic Device (PLD), a Field Programmable Gate Array (FPGA), a processor, a controller, a microcontroller, or a microprocessor.

In addition, when implemented in firmware or software, an embodiment of the present disclosure may be implemented in the form of modules, procedures, or functions that perform the functions or operations described above, and may be recorded on a computer-readable recording medium using various computer means. Here, the recording medium may include program instructions, data files, data structures, or any combination thereof.

The program instructions recorded on the recording medium may be specially designed and configured for the present disclosure, or may be known and available to those skilled in the field of computer software. For example, the recording medium may include magnetic media such as hard disks, floppy disks, and magnetic tapes; optical media such as CD-ROMs (Compact Disc Read Only Memory) and DVDs (Digital Video Discs); magneto-optical media such as floptical disks; and hardware devices specially configured to store and execute program instructions, such as ROM, RAM, and flash memory.

Examples of the program instructions may include not only machine code generated by a compiler but also high-level language code that can be executed by a computer using an interpreter or the like. Such hardware devices may be configured to operate as one or more pieces of software to perform the operations of the present disclosure, and vice versa.

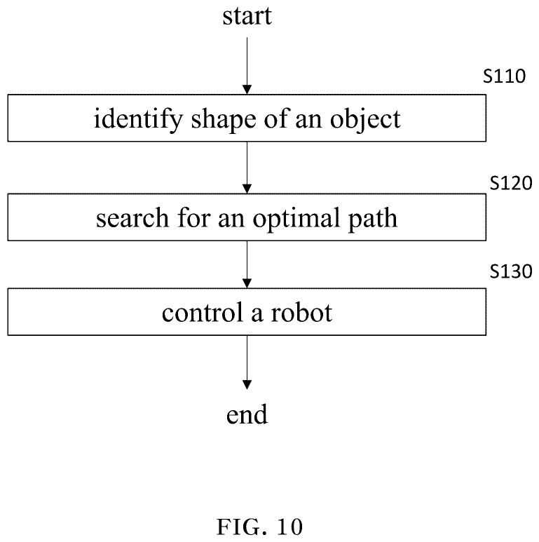

FIG. 10 is a flowchart for explaining a path setting method for a robot based on the shape of an object according to an embodiment of the disclosure.

Referring to FIG. 10, in step S110, the control server may identify the shape of an object to be transported by the robot based on video footage of an industrial site where the robot is present.

Specifically, the control server may identify the shape of an object to be transported by the robot based on video collected from the camera. That is, the control server may utilize an object detection model capable of recognizing objects in the video to extract data such as the shape, size, color, and position of the object to be transported.

Next, in step S120, the control server may simulate a work path related to the movement of the robot based on the identified shape of the object, and may search for an optimal path to avoid collisions with a worker.

Specifically, the control server may test various paths through simulation for moving the object to a designated location while the object is being held, and may predict potential collision risks with the worker.

In this process, the control server may define a danger area corresponding to the worker's range of motion and may search for an optimal path for transporting the object within a safe area that excludes the danger area, based on the shape of the object. Here, the danger area may be set according to the expected movement path of the worker. However, the danger area is not limited thereto and may also be designated arbitrarily by an administrator.

Here, the control server may recognize the face of a worker within the video captured by the camera to identify the worker, estimate the worker's expected movement path based on the position, direction, and gaze of the identified face, and search for an optimal path based on the estimated expected movement path of the worker.

In this case, the control server may track the movement of the worker by analyzing multiple frames included in the video, and may dynamically control the frame rate of the video in real time according to the number of workers recognized in the video. In addition, the control server may track the movement of the worker by analyzing multiple frames included in the video, estimate a workload based on the worker's movement, and dynamically control the frame rate of the video in real time according to the estimated workload.

Then, in step S130, the control server may control the robot according to the searched optimal path.

In this process, the control server may output the video captured during the robot control operation in real time, while performing de-identification processing on the recognized face of the worker.

In one embodiment, the control server may estimate whether the identified worker is wearing personal protective equipment based on the shape of the worker's recognized face, and may replace the recognized face in the video with a preset image according to the estimated result.

In another embodiment, the control server may estimate the fatigue level of the identified worker based on at least one variation among the pattern, frequency, and speed of the worker's movements, and may output the transformed image with a different color based on the estimated fatigue level.

In another embodiment, the control server may identify the torso of the worker based on the recognized face of the worker, extract the edge of the identified torso, and modify the shape of the extracted edge based on a pre-stored reference body shape.

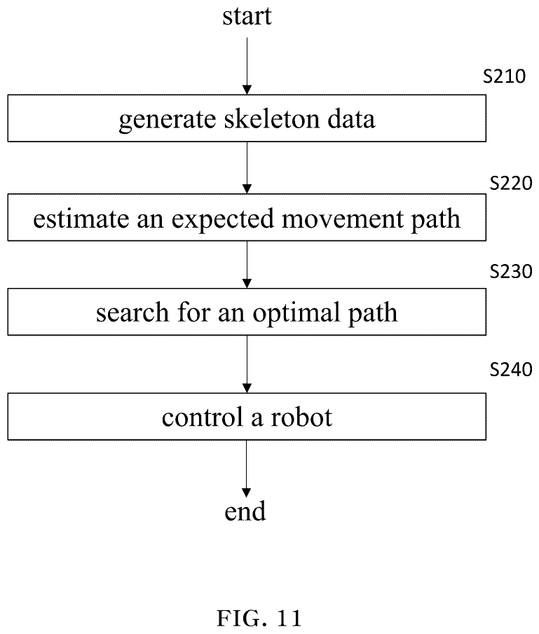

FIG. 11 is a flowchart for explaining a skeleton-based industrial site monitoring method according to an embodiment of the disclosure.

Referring to FIG. 11, in step S210, the control server may recognize joint points of a worker based on video footage of an industrial site where the robot is present, and may generate skeleton data.

Specifically, the control server may extract skeleton data including body joint coordinates from the video captured by the camera, based on a pre-trained pose estimation algorithm.

Next, in step S220, the control server may analyze the current position and posture of the worker based on the extracted skeleton data. That is, the control server may determine not only the overall position of the worker but also the directions of body parts such as the head, arms, and legs using the coordinates of each joint.

Subsequently, the control server may track the movement path of the worker in real time using the worker's skeleton data. Specifically, the control server may estimate the movement direction and speed of the worker based on changes in the positions of body feature points derived from skeleton data generated by a pre-trained artificial intelligence model, and may estimate an expected movement path based on the estimated movement direction and speed.

In this process, the control server may estimate the type of task based on the estimated expected movement path and may correct the expected movement path based on the estimated task type.

Next, in step S230, the control server may search for an optimal path for the robot to avoid collisions with the worker based on the estimated expected movement path of the worker. That is, the control server may set the optimal path for the robot to avoid the worker's movement path based on the expected movement path.

Then, in step S240, the control server may control the robot according to the searched optimal path.

In this process, the control server may track the movement of the worker, match the tracked movement with the estimated expected movement path in real time, and recognize the movement as abnormal if the distance between the worker's movement and the expected movement path exceeds a preset value.

When estimating the worker's movement, the control server may divide the video into a dynamic region set based on the expected movement path and a static region corresponding to the remaining area excluding the dynamic region, and may track the worker's movement by analyzing the dynamic region. Here, the control server may generate a virtual worker of a preset size based on the skeleton data and may set the dynamic region based on the movement of the generated virtual worker along the expected movement path. The control server may also perform masking on the separated static region.

The control server may also track the movement of the worker based on the skeleton data, estimate a risk level based on the difference between the expected movement path and the worker's actual movement, and reset the expected movement path when the estimated risk level exceeds a preset value. Here, the control server may estimate a risk level based on the difference between the reset expected movement path and the worker's movement, and may compare the risk level corresponding to the reset expected movement path with that of the previous expected movement path. If the difference in risk levels is less than a preset value, the control server may output a warning signal.

As described above, although preferred embodiments of the present disclosure have been disclosed in this specification and the accompanying drawings, it will be apparent to those skilled in the art that various modifications based on the technical spirit of the present disclosure are also possible in addition to the embodiments disclosed herein. Furthermore, specific terms used in this specification and drawings are intended to facilitate the understanding of the present disclosure and are used in a general sense to explain the technical contents of the invention more clearly, and are not intended to limit the scope of the invention. Accordingly, the above detailed description should not be construed as limiting but merely illustrative in all aspects. The scope of the present disclosure should be determined by a reasonable interpretation of the appended claims, and all modifications within the equivalent scope of the present disclosure should be construed as being included within the scope of the invention.

What is claimed is:

1. A skeleton-based industrial site monitoring method comprising:
generating skeleton data, by a control server, by recognizing joint points of a worker based on a captured video of the industrial site where a robot is present;
estimating, by the control server, an expected movement path of the worker based on the generated skeleton data;
searching, by the control server, for an optimal path for the robot to avoid collision with the worker based on the estimated expected movement path of the worker; and
controlling, by the control server, the robot according to the searched optimal path.

2. The method of claim 1, wherein the estimating comprises:
estimating movement direction of the worker and movement speed of the worker based on changes in positions of body feature points based on the generated skeleton data; and
estimating the expected movement path based on the estimated movement direction of the worker and the movement speed of the worker.

3. The method of claim 2, wherein the estimating comprises:
estimating a type of task based on the estimated expected movement path; and
modifying the estimated expected movement path based on the estimated type of task.

4. The method of claim 3, wherein the controlling comprises:
matching tracked movement of the worker with the estimated expected movement path in real time by tracking the movement of the worker; and
determining the movement of the worker as abnormal in case that distance between the movement of the worker and the expected movement path exceeds a preset value.

5. The method of claim 4, wherein the controlling comprises:
dividing the captured video into a dynamic region set based on the expected movement path and a static region corresponding to remaining area in the captured video excluding the dynamic region, and
tracking the movement of the worker by analyzing the dynamic region.

6. The method of claim 5, wherein the controlling comprises:
generating a virtual worker of a preset size based on the skeleton data; and
determining the dynamic region based on movement of the generated virtual worker along the expected movement path.

7. The method of claim 5, wherein the controlling comprises:
performing masking on the static region.

8. The method of claim 1, wherein the controlling comprises:
tracking the movement of the worker based on the skeleton data;
estimating a risk level based on the difference between the expected movement path and the movement of the worker; and
resetting the expected movement path in case that the estimated risk level exceeds a preset value.

9. The method of claim 8, wherein the controlling comprises:
estimating a risk level based on the difference between the reset expected movement path and the movement of the worker; and
displaying a warning signal in case that the difference between the risk level corresponding to the reset expected movement path and the risk level corresponding to the expected movement path before resetting is less than a preset value.

10. A computer program recorded on a recording medium, combined with a computing device comprising:
a memory;
a transceiver; and
a processor that processes instructions stored in the memory,
wherein the processor is configured to:
generate skeleton data by recognizing joint points of a worker based on a captured video of the industrial site where a robot is present;
estimate an expected movement path of the worker based on the generated skeleton data;
search for an optimal path for the robot to avoid collision with the worker based on the estimated expected movement path of the worker; and
control the robot according to the searched optimal path.
